(19) United States
(12) Patent Application Publication
(10) Pub. No.: US 2026/0059239 A1
(43) Pub. Date: Feb. 26, 2026

(54) ACOUSTIC BEAMFORMING SYSTEM

(71) Applicant: Soundskrit Inc., Montreal (CA)

(72) Inventor: Anton Schirg, Montreal (CA)

(21) Appl. No.: 19/304,952

(22) Filed: Aug. 20, 2025

Related U.S. Application Data
(60) Provisional application No. 63/685,109, filed on Aug. 20, 2024.

(51) Int. Cl. H04R 3/00; H04R 1/08; H04R 1/40

(52) U.S. Cl. CPC H04R 3/005; H04R 1/08; H04R 1/406; H04R 2201/021; H04R 2430/20

(57) ABSTRACT

An acoustic beamforming system includes a plurality of microphones including at least a first directional microphone having a first directional beam pattern, the first directional microphone arranged such that the first directional beam pattern points in a first direction other than a forward direction, a second directional microphone having a second directional beam pattern, the second directional microphone arranged such that the second directional beam pattern points in a second direction other than the forward direction, and an omnidirectional microphone. The acoustic beamforming system also includes a processing system configured to combine outputs of the plurality of microphones to create a beamformed directional pattern that points at least approximately in the forward direction.

### CROSS-REFERENCE TO RELATED APPLICATION

This application claims the benefit of U.S. provisional application entitled “Acoustic Beamforming System with Wall-Mounted Directional Microphones,” filed Aug. 20, 2024, and assigned Ser. No. 63/685,109, the entire disclosure of which is hereby expressly incorporated by reference.

### BACKGROUND OF THE DISCLOSURE

### Field of the Disclosure

The disclosure relates generally to acoustic beamforming systems that include microphones.

### Brief Description of Related Technology

Various products, including, but not limited to, video doorbells, intercoms, and ceiling microphone arrays, are either very thin or flush-mounted against a wall while trying to capture audio in front of them (e.g., the voice of someone speaking). In these scenarios, directional pickup patterns may be used for picking up the voice of someone in front of the product, while rejecting surrounding background noise.

Typical directional microphones involve the use of two sound ports. When integrated into an end product, the two sound ports in the end product enclosure are typically aligned in the direction in which the directional microphone picks up sound. Thus to capture the voice of a user in front of a wall-mounted device, the directional microphone is integrated in a way such that the two sound ports in the wall-mounted device are spaced apart along the thickness of the device. If the device is relatively thin, then the spacing between the two sound ports may be small, such that the directional microphone exhibits low sensitivity or a low signal-to-noise ratio (SNR). If the device is mounted and/or otherwise configured such that it is flush (e.g., completely flush) with the wall, then there is no available space to integrate the directional microphone, even with low sensitivity.

In some cases, an array of omnidirectional may be used to create a directional pickup pattern. However, directionality of the created pickup patterns may be insufficient and/or the size of the array may be too large, for at least some applications.

### SUMMARY OF THE DISCLOSURE

In accordance with one aspect of the disclosure, an acoustic beamforming system includes a plurality of microphones including at least a first directional microphone having a first directional beam pattern, the first directional microphone arranged such that the first directional beam pattern points in a first direction other than a forward direction, a second directional microphone having a second directional beam pattern, the second directional microphone arranged such that the second directional beam pattern points in a second direction other than the forward direction, and an omnidirectional microphone. The acoustic beamforming system also includes a processing system configured to combine outputs of the plurality of microphones to create a beamformed directional pattern that points at least approximately in the forward direction.

In accordance with another aspect of the disclosure, an acoustic beamforming system includes a first directional microphone configured to couple to a first pair of sound ports and having a first directional beam pattern, the first directional microphone arranged such that the first directional beam pattern points in a first direction other than a forward direction. The acoustic beamforming system also includes a second directional microphone configured to couple to a second pair of sound ports and having a second directional beam pattern, the second directional microphone arranged such that the second directional beam pattern points in a second direction other than the forward direction. The acoustic system further includes an omnidirectional microphone configured to couple to a single sound port. The omnidirectional microphone is positioned between the first directional microphone and the second directional microphone. The first pair of sound ports configured to couple to the first directional microphone, the second pair of sound ports configured to couple to the second directional microphone, and the single sound port configured to couple to the omnidirectional microphone are aligned along a first axis that is at least approximately perpendicular to the forward direction. The first directional microphone and the second directional microphone are arranged such that the first directional beam pattern and the second directional beam pattern point along the first axis.

In connection with any one of the aforementioned aspects, the devices and/or methods described herein may alternatively or additionally include or involve any combination of one or more of the following aspects or features. The first directional microphone is configured to generate a first directional output signal having first dipole beam pattern including a first positive dipole portion and a first negative dipole portion that is out of phase with the first positive dipole portion. The second directional beam pattern is configured to generate a second directional output signal having a second dipole beam pattern including a second positive dipole portion and a second negative dipole portion that is out of phase with the second positive dipole portion. The processing system is configured to generate a differential output signal based on the first directional output signal and the second directional output signal, where the differential output signal comprises a second order dipole beam pattern that is narrower that the first dipole beam pattern and the second dipole beam pattern. The processing system is further configured to combine the differential output signal with an omnidirectional output signal generated by the omnidirectional microphone, to generate the beamformed directional pattern that points at least approximately in the forward direction. The processing system is further configured to, prior to combining the differential output signal with the omnidirectional output signal, filter the differential output signal and the omnidirectional output signal with respective matching filters to match amplitudes and phases of the differential output signal and the omnidirectional output signal with one another, respectively. The processing system is further configured to, prior to generating the differential output signal and combining the differential output signal with the omnidirectional output signal, filter each of the first directional output signal, the second directional output signal, and the omnidirectional output signal with a respective filter. The plurality of microphones further comprises a third directional microphone configured to couple a third pair of sound ports and having a third directional beam pattern, the third directional microphone arranged such that the third directional beam pattern points in a third direction other than the forward direction, and a fourth directional microphone configured to couple to a fourth pair of sound ports and having a fourth directional beam pattern, the fourth directional microphone arranged such that the fourth directional beam pattern points in a fourth direction other than the forward direction. The plurality of microphones is further arranged such that the third pair of sound ports configured to couple to the third directional microphone, the fourth pair of sound ports coupled to couple to the fourth directional microphone, and the single sound port configured to couple to the omnidirectional microphone are aligned along a second axis that is at least approximately perpendicular to the forward direction and at least approximately perpendicular to the first axis, and the third directional microphone and the fourth directional microphone are arranged such that the third directional beam pattern and the fourth directional beam pattern point along the second axis. The plurality of microphones further comprises a third directional microphone having a third directional beam pattern, the third directional microphone arranged such that the third directional beam pattern points in a third direction other than the forward direction. The plurality of microphones is arranged such that the first directional microphone, the second directional microphone, and the third directional microphone radially surround the omnidirectional microphone and are arranged such that the first directional beam pattern, the second directional beam pattern, and the third directional beam pattern point along respective radial axis around the omnidirectional microphone. The processing system comprises a digital signal processor. The plurality of microphones is configured to be integrated into a wall-mounted device. The plurality of microphones is configured to be integrated into a wall-mounted device that is flush with a wall. The acoustic beamforming system further comprising a processing system configured to combine outputs of the first directional microphone, the second directional microphone, and the omnidirectional microphone to create a beamformed directional pattern that points at least approximately in the forward direction. The first directional microphone is configured to generate a first directional output signal having first dipole beam pattern including a first positive dipole portion and a first negative dipole portion that is out of phase with the first positive dipole portion. The second directional microphone is configured to generate a second directional output signal having a second dipole beam pattern including a second positive dipole portion and a second negative dipole portion that is out of phase with the second positive dipole portion. The processing system is configured to generate a differential output signal based on the first directional output signal and the second directional output signal, where the differential output signal comprises a second order dipole beam pattern that is narrower that the first dipole beam pattern and the second dipole beam pattern. The processing system is further configured to combine the differential output signal with an omnidirectional output signal generated by the omnidirectional microphone, to generate the beamformed directional pattern that points at least approximately in the forward direction. The processing system is further configured to, prior to combining the differential output signal with the omnidirectional output signal, filter the differential output signal and the omnidirectional output signal with respective matching filters to match amplitudes and phases of the differential output signal and the omnidirectional output signal with one another, respectively. The processing system is further configured to, prior to generating the differential output signal and combining the differential output signal with the omnidirectional output signal, filter each of the first directional output signal, the second directional output signal, and the omnidirectional output signal with a respective filter. The acoustic beamforming system further includes a third directional microphone configured to couple to a third pair of sound ports and having a third directional beam pattern, the third directional microphone arranged such that the third directional beam pattern points in a third direction other than the forward direction, and a fourth directional microphone configured to couple to a fourth pair of sound ports and having a fourth directional beam pattern, the fourth directional microphone arranged such that the fourth directional beam pattern points in a fourth direction other than the forward direction. The third pair of sound ports configured to couple to the third directional microphone, the fourth pair of sound ports configured to couple to the fourth directional microphone, and the single sound port configured to couple to the omnidirectional microphone are aligned along a second axis that is at least approximately perpendicular to the forward direction and at least approximately perpendicular to the first axis. The third directional microphone and the fourth directional microphone are arranged such that the third directional beam pattern and the fourth directional beam pattern point along the second axis. The acoustic beamforming system further includes a third directional microphone having a third directional beam pattern, the third directional microphone arranged such that the third directional beam pattern points in a third direction other than the forward direction. The first directional microphone, the second directional microphone, and the third directional microphone radially surround the omnidirectional microphone and are arranged such that the first directional beam pattern, the second directional beam pattern, and the third directional beam pattern point along respective radial axis around the omnidirectional microphone.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1A illustrates a top view of a wall-mounted device used to pick up the voice of a user in front of the device according to one example.

FIG. 1B illustrates a front view of the wall-mounted device of FIG. 1A in accordance with one example.

FIG. 2 illustrates the beam patterns of the microphones of the device of FIG. 1B at different stages of the beamforming process in accordance with one example.

FIG. 3 shows a block diagram schematic of a method configured to create a beamformed signal in accordance with one example.

FIG. 4 shows a block diagram of a method used to create a beamformed signal in accordance with another example.

FIGS. 5A and 5B are graphical plots depicting a two-dimensional (2D) polar pattern and a three-dimensional (3D) polar pattern of the beamformer output for a wall mounted device, respectively, in accordance with an example.

FIG. 6A illustrates a wall-mounted device in which an acoustic beamforming system includes embedded microphones used to create a beamformer that is narrow in both the horizontal and vertical planes in front of the device in accordance with one example.

FIG. 6B shows a 3D polar plot of the beamformer output of the acoustic beamforming system from FIG. 6A.

FIG. 7A illustrates a wall-mounted device in which an acoustic beamforming system includes embedded microphones used to create a beamformer that is narrow in both the horizontal and vertical planes in front of the device in accordance with another example.

FIG. 7B shows a 3D polar plot of the beamformer output of the acoustic beamforming system from FIG. 7A.

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Described herein are acoustic beamforming systems in which outputs of multiple directional microphones are combined to create a directional audio pickup in front of a wall-mounted device. The acoustic beamforming systems are configured such that the multiple directional microphones can be integrated into the end product (e.g., the wall-mounted device), even if the end product is completely flush with the surrounding wall. The acoustic beamforming systems may advantageously maintain a relatively compact form factor while providing better directional performance as compared to systems in which an array of omnidirectional microphones are used.

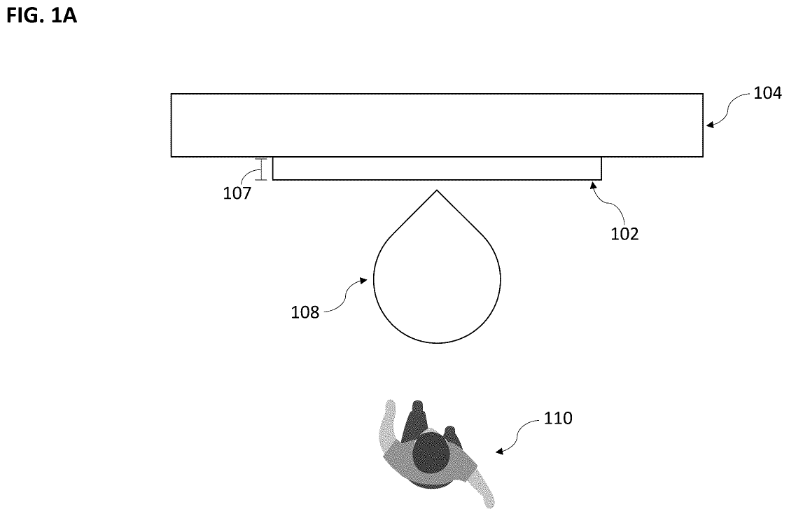

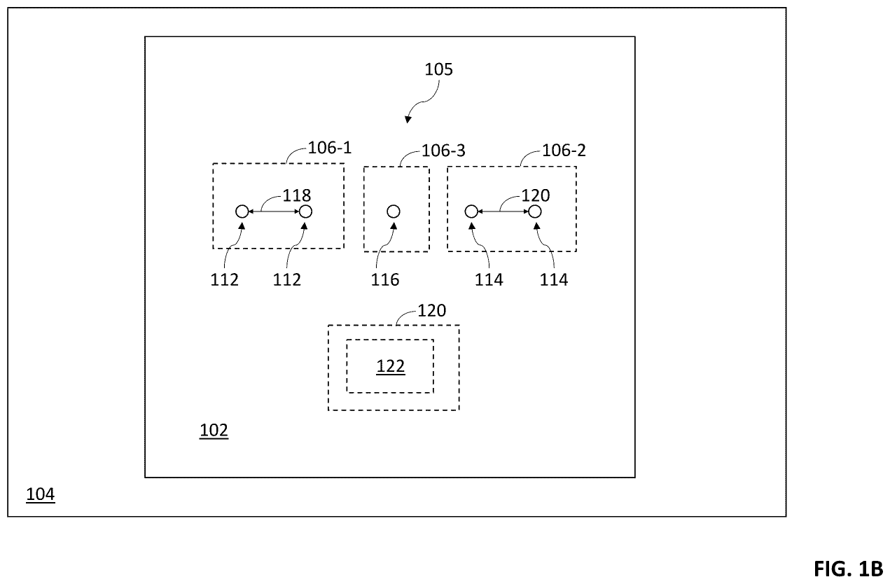

FIG. 1A illustrates a top view of a wall-mounted device 102 used to pick up the voice of a user in front of the device according to one example. The wall-mounted device 102 is mounted to a wall 104. The wall-mounted device 102 may be any device configured to capture audio such as a video doorbell, intercom, or security device. The wall-mounted device 102 has a thickness 107. Integrated inside the wall-mounted device 102, but not shown in FIG. 1A, are a plurality of microphones. The plurality of microphones includes at least three microphones, for example. The wall-mounted device 102 also includes a computing device or other processor (not shown in FIG. 1A). As described in more detail below, the computing device or other processor may implement a processing system configured to combine and process output signals from the plurality of microphones to provide or create a beamformer 108 that establishes or provides a directional pickup pattern. In this example, the beamformer 108 is used to pick up the voice of an individual 110 in front the wall-mounted device 102 while attenuating surrounding background noise. In some examples, the wall-mounted device 102 may be integrated inside the wall so that the wall-mounted device 102 sits flush with the wall 104 such that the thickness 107 is effectively zero.

FIG. 1B illustrates a front view of the wall-mounted device 102 mounted to the wall 104 in accordance with one example. Embedded inside the wall-mounted device 102 is an acoustic beamforming system 105 comprising a plurality of microphones 106. The plurality of microphones 106 includes two microphones (e.g., directional microphones), including a first directional microphone 106-1 (sometimes referred to herein as “left directional microphone”) and a second directional microphone 106-2 (sometimes referred to herein as “right directional microphone”), in the illustrated example. The plurality of microphones 106 also includes an omnidirectional microphone 106-3, in the illustrated example. The microphones 106 may be embedded in the wall-mounted device 102 and may be not visible on the surface of the enclosure of wall-mounted device 102.

On the surface of the enclosure of wall-mounted device 102 is pair of left sound ports 112 that couple to the left directional microphone 106-1 embedded inside of the device 102.

Additionally, on the surface of the enclosure of wall-mounted device 102 is a pair right sound ports 114 that couple to the right directional microphone 106-2 embedded inside of the device 102. Further, a sound port 116 on the surface of the device 102 couples to the omnidirectional microphone 106-3 embedded inside of device 102. The two left sound ports 112 have a spacing 118 therebetween and the two right sound ports 114 have a spacing 120 therebetween. In some examples, the spacing 118 is about equal to the spacing 120. In FIG. 1B, the sound port 116 is positioned such that it is symmetrically disposed between and aligned with the left sound ports 112 and the right sound ports 114. However, in other examples, the sound ports 112, 114, and 116 may be arbitrarily positioned relatively to one another so long as the sound ports 112, 114, and 116 are sufficiently (e.g., somewhat) close to one another to establish the beamformer and directional pickup pattern.

Although three microphones 106 are illustrated in FIG. 1B, a different number of microphones 106 may be embedded in the wall-mounted device 102 in other examples. For example, the plurality of microphones 106 may include one or more additional directional microphones, in some examples. In such examples, the enclosure of wall-mounted device 102 may include additional sound ports that couple to the additional microphones 106, in some examples.

In an example, the first directional microphone 106-1 has or generates a first directional beam pattern and the second directional microphone 106-2 has or generates a second directional beam pattern. The first directional beam pattern and the second directional beam pattern may each comprise a dipole. In other examples, the first directional beam pattern and/or the second directional beam pattern may be a directional beam pattern other than a dipole. The first directional microphone 106-1 may be arranged such the first directional beam pattern points or lies along a first direction other than a forward direction in front of the wall-mounted device 102. The second directional microphone 106-2 may be arranged such the second directional beam pattern points or lies along a second direction other than the forward direction. In an example, the first directional microphone 106-1 and the second directional microphone 106-2 may be arranged such that dipoles of the first directional microphone 106-1 and the second directional microphone 106-2 lie along an axis that is at least approximately perpendicular to the forward direction. For example, the first directional microphone 106-1 and the second directional microphone 106-2 may be arranged such that the dipoles of the first directional microphone 106-1 and the second directional microphone 106-2 lie along an axis on the surface of the wall-mounted device 102 that is at least approximately perpendicular to the forward direction.

The omnidirectional microphone 106-3 may be positioned between the first directional microphone 106-1 and the second directional microphone 106-2. The sound port 116 coupled to the omnidirectional microphone 106-3 may thus be positioned between the pair of left sound ports 112 coupled to the first directional microphone 106-1 and the pair of right sound ports 114 coupled to the second directional microphone 106-2. The sound ports 112, 114, 116 may be aligned along an axis that is at least approximately perpendicular to the forward direction.

The wall-mounted device 102 may also include, or be otherwise coupled to, a computing device or other processor 120 configured to implement or otherwise execute a processing system 122. The processing system 122 may be configured to combine outputs (i.e., output signals) of the plurality of microphones 106 to create a beamformed directional pattern that points at least approximately in the forward direction. For example, the processing system 122 is configured to combine outputs of the plurality of microphones 106 to provide or create the beamformer 108 that establishes or provides a directional pickup pattern that points in the forward direction.

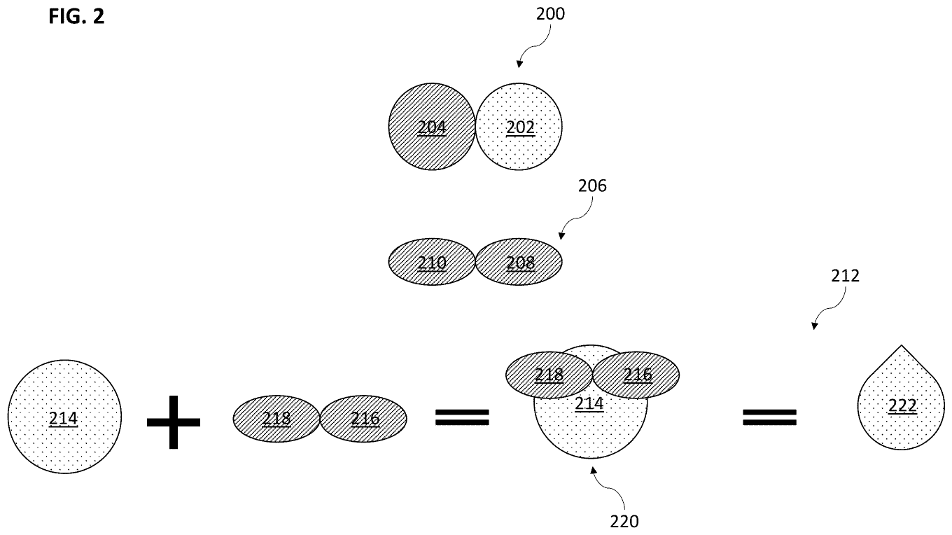

FIG. 2 illustrates the beam patterns of the microphones 106 of the device of FIG. 1B at different stages of the beamforming process in accordance with one example. In a first stage 200, before any of the individual microphone signals are combined, each of two dipoles has a dipole beam pattern. The dipole beam pattern includes two lobes 202, 204. A positive portion of the dipole lobe 202 is 180 degrees out of phase with a negative portion of the dipole lobe 204. The output signal of the dipole for sound approaching the microphones on the positive portion 202 will be oppositely phased compared to sound approaching the microphones from the negative portion 204. In the second stage 206 of the beamformer, the two dipole microphones of FIG. 1B may be treated as a differential array with outputs thereof subtracted. When doing so, a second order dipole microphone is created. The second order dipole 206 has a narrower directionality than the typical first order dipole 200. Additionally, unlike the dipole beam pattern 200 with a positively phased portion 202 and a negatively phased portion 204, the second order dipole 206 has two portions 208 and 210 that are of equal phase. For example, the second order dipole portions 208 and 210 may both have a negative phase relative to the original dipole 200. The second order dipole 206 has directional sensitivity pointed parallel to the wall-mounted device 102. In other words, the second order dipole 206 rejects the voice of the user 110 in front of the device 102 while picking up unwanted sounds off to the sides.

In the third stage of the beamformer 212, the second order dipole 206 is combined with the output of the omnidirectional microphone pattern 214. The omnidirectional microphone pattern 214 is positively phased relative to the negatively phased dipole pattern 206. In other words, the pattern 214 is oppositely phased relative to patterns 208 and 210. When the output of the second order dipole is combined with the omnidirectional microphone output, the two beam patterns overlap as shown at 220. When their outputs are added, the positive and negative portions cancel, leaving only the area without any overlap. Thus a resulting beamformed signal 222 is created. The beamformed signal 222 points in front of the wall-mounted device 102 (FIGS. 1A-B) in the direction of the user 110, while rejecting a significant amount of sound directed to the device from the sides.

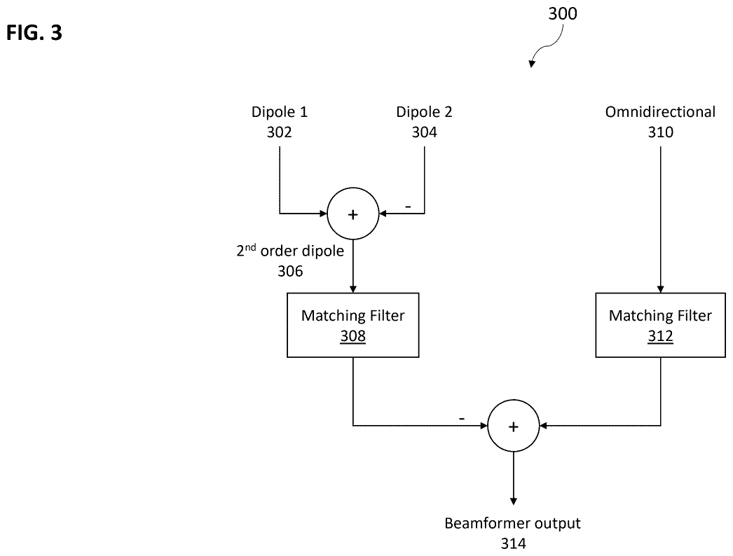

FIG. 3 shows a block diagram schematic of a method 300 configured to create the beamformed signal 222 (FIG. 2) in accordance with one example. A left dipole 302 and a right dipole 304 that lay on the same axis are subtracted from one another to create a second order dipole 306. The second order dipole 306 is passed through a matching filter 308 and the omnidirectional microphone output 310 is passed through a matching filter 312. The matching filters 310 and 312 ensure that the outputs of the second order dipole 306 and omnidirectional microphone 310 are matched with one another in terms of both amplitude (e.g., frequency response) and phase response. After matching the two outputs 306 and 310, the second order dipole output 306 is subtracted from the omnidirectional output 310 to create the final beamformer output 314 that is used to isolate, sound, e.g., a voice of an individual, in front of the wall mounted device.

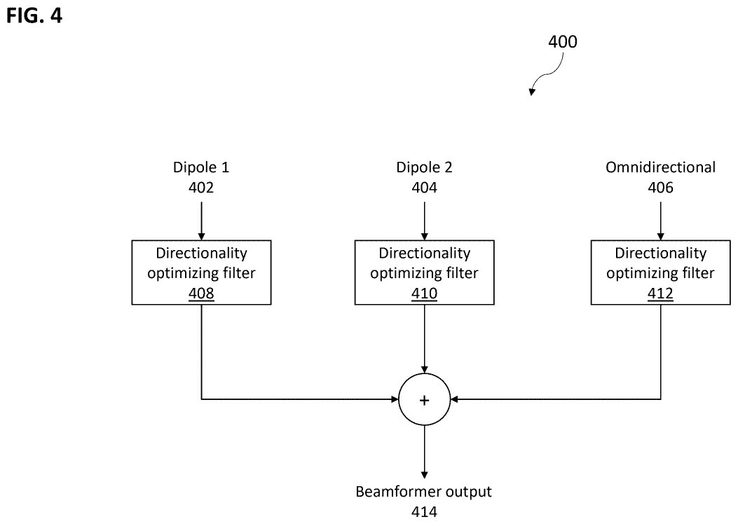

FIG. 4 shows a block diagram of a method 400 used to create the beamformed signal 222 (FIG. 2) in accordance with another example. A left dipole 402, a right dipole 404, and an omnidirectional microphone 406 are all simultaneously passed through filters 408, 410, and 412 respectively. The filters 408, 410, and 412 modify the amplitude and phase of the respective microphones accordingly so that when combined, the beamformer output 414 has the greatest performance. The filters may be tuned in order to maximize either the signal-to-noise ratio (SNR), directivity, or any other performance parameter or combination of parameters of the beamformer output 412.

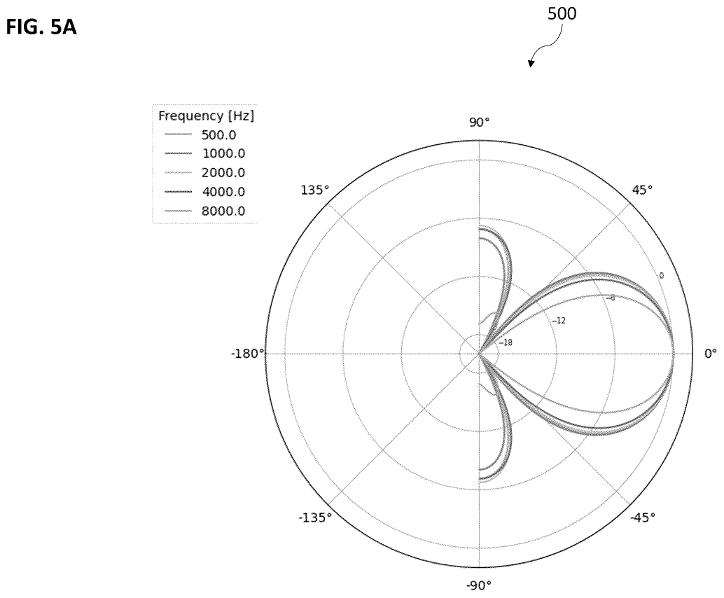

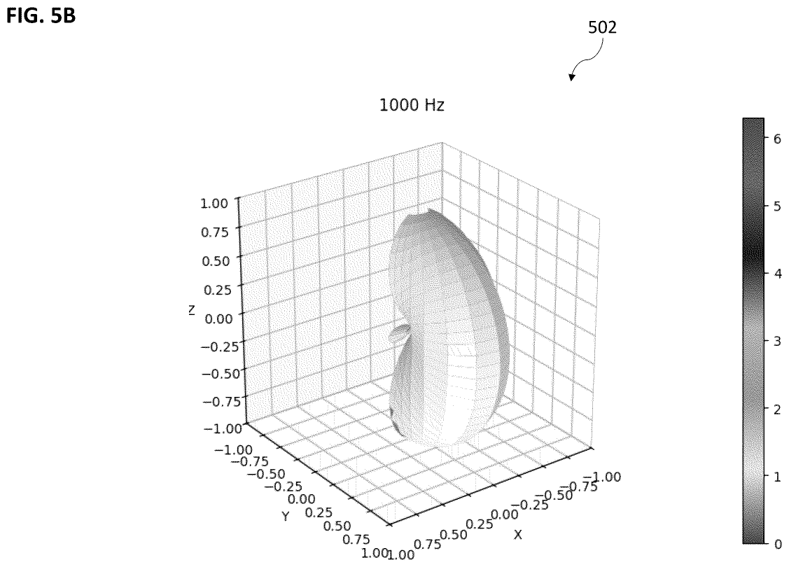

FIGS. 5A and 5B are graphical plots depicting a two-dimensional (2D) polar pattern 500 and a three-dimensional (3D) polar pattern 502 of the beamformer output for a wall mounted device as described in connection with FIG. 1, in which each dipole is spaced about 15 millimeters (mm) to the left and right of the omnidirectional microphone, respectively. The 2D polar pattern 500 shows the directionality of the beamformer output along the horizontal or azimuthal plane relative to the wall-mounted device. The zero-degree direction corresponds to the direction of the individual 110 (FIG. 1A) directly in front of the wall mounted device. As shown in the polar pattern 500, the beamformer output picks up sound in front of the wall-mounted device with high sensitivity relative to the sides. Thus, the beamformer is able to effectively pick up the voice of the individual while rejecting surrounding background noise. The beamformer output also remains relatively consistent as a function of frequency across the audible spectrum.

The 3D polar pattern 502 shows the directionality of the beamformer output at 1 kilohertz (kHz) along both the horizontal (azimuthal) and vertical plane. The beamformer output is relatively narrow along the horizontal plane, but wide along the vertical plane. In some scenarios, this configuration may be used to ensure that the voices of users of different heights are equally captured, for example.

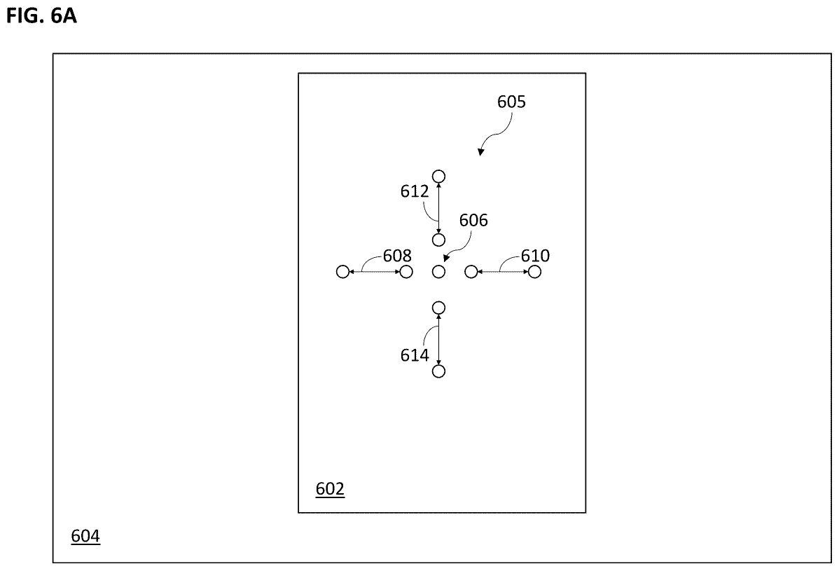

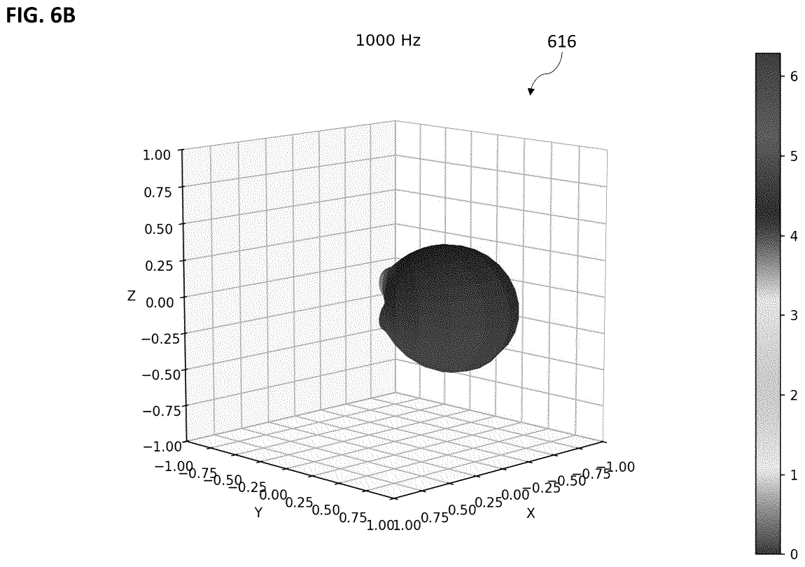

In some cases, it may be useful to create a beamformer that is also narrow in the vertical plane. FIG. 6A illustrates a wall-mounted device 602 equipped with an acoustic beamforming system 605 that includes embedded microphones used to create a beamformer that is narrow in both the horizontal and vertical planes in front of the device, in accordance with one example. The wall mounted device 602 is mounted on a wall 604. Embedded in the wall mounted device 602 is an omnidirectional microphone 606 surrounded by four directional microphones. The omnidirectional microphone 602 may be the same as or similar to the omnidirectional microphone 106-3 of FIG. 1B. The four directional microphones may be the same as or similar to the directional microphones 106-1, 106-2 of FIG. 1B. The four directional microphones may dipole microphones, for example. The acoustic beamforming system 605 may include a left horizontal dipole microphone 608 and a right horizontal dipole microphone 610. The left horizontal dipole microphone 608 and the right horizontal dipole microphone 610 may be arranged such that the dipoles of the left horizontal dipole microphone 608 and the right horizontal dipole microphone 610 lie along a horizonal axis on the surface of the wall-mounted device 602. The acoustic beamforming system 605 may also include a top vertical dipole microphone 612 and a bottom vertical dipole microphone 614. The top vertical dipole microphone 612 and the bottom vertical dipole microphone 614 may be arranged such that the dipoles of the top vertical dipole microphone 612 and the bottom vertical dipole microphone 614 lie along a vertical axis on the surface of the wall-mounted device 602. The omnidirectional microphone 602 may be arranged to couple to a sound port that is positioned at the intersection of the horizontal axis and the vertical axis on the surface of the wall-mounted device 602. In some examples, the dipole microphones 608, 610, 612, and 614 are equidistant from the omnidirectional microphone 606. The outputs of the top vertical dipole microphone 612 and bottom vertical dipole microphone 614 may be processed in a similar way to the dipoles described in connection with FIG. 1-5 in order to provide additional noise rejection in the vertical plane.

FIG. 6B shows a 3D polar plot 616 of the beamformer output of the acoustic beamforming system from FIG. 6A. The beamformer is narrow in both the horizontal and vertical planes in front of the wall-mounted device 602 and creates a directional beam that can be used to isolate a voice in front of the device, such as the individual 110 shown in FIG. 1A.

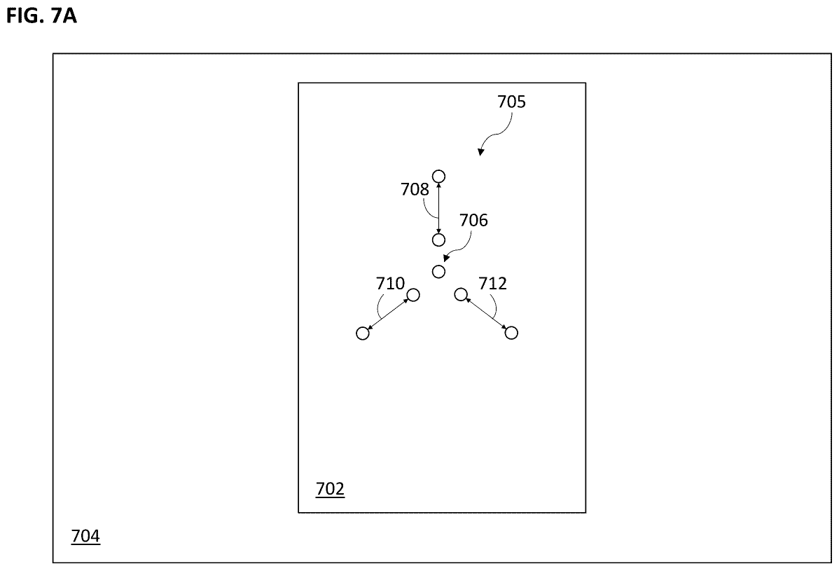

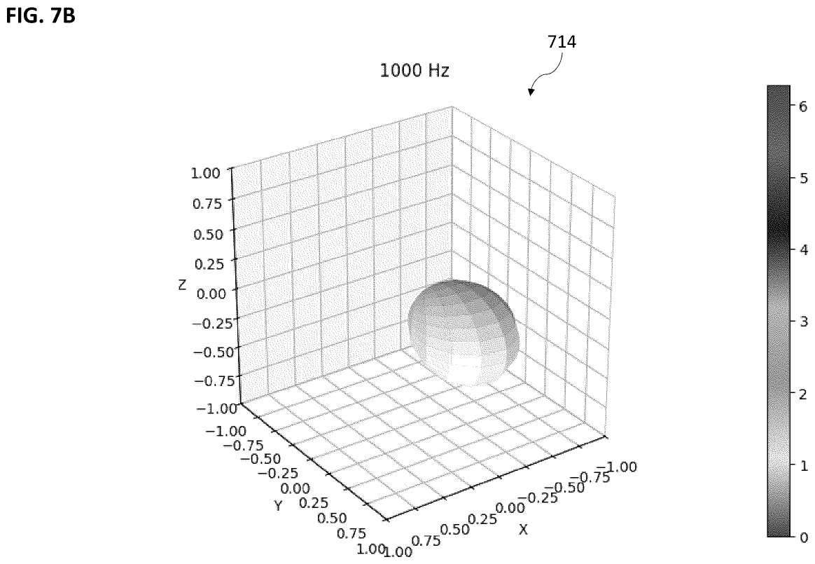

In some cases, it may be useful to reduce the total number of microphones used to create a beamformer that is narrow in both the horizontal and vertical planes. FIG. 7A illustrates a wall-mounted device 702 equipped with an acoustic beamforming system 705. The acoustic beamforming system 705 is generally similar to the acoustic beamforming system 605 of FIG. 6A but includes embedded microphones used to create a beamformer that is narrow in both the horizontal and vertical planes in front of the device, with a reduced number of microphones as compared to the acoustic beamforming system 605 of FIG. 6A. The wall mounted device 702 is mounted on a wall 704. Embedded in the wall-mounted device 702 are an omnidirectional microphone 706 and three directional microphones surrounding the omnidirectional microphone, instead of four as in FIG. 6A. The three directional microphones surround the omnidirectional microphone 706 in a triangular pattern, with respective sound ports of the three directional microphones aligned in a direction pointing radially outwards. The three directional microphones include a top corner dipole 708, a left corner dipole 710, and a right corner dipole 712.

The combination of the three directional microphones 708, 710, and 712 provide directional sound information across both the horizontal and vertical directions relative to the wall-mounted device 702. The microphones in the wall-mounted device 702 may be processed in a manner similar to that described in connection with FIGS. 1-5 to create a beamformed output.

FIG. 7B shows a 3D polar plot 714 of the beamformer output of the acoustic beamforming system of FIG. 7A. The beamformer is narrow in both the horizontal and vertical planes in front of the wall-mounted device 702 and creates a directional beam that can be used to isolate a voice in front of the device, such as the individual 110 shown in FIG. 1A.

The terms “about” or “at least approximately” are used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. An acoustic beamforming system, comprising:
a plurality of microphones including at least
a first directional microphone having a first directional beam pattern, the first directional microphone arranged such that the first directional beam pattern points in a first direction other than a forward direction,
a second directional microphone having a second directional beam pattern, the second directional microphone arranged such that the second directional beam pattern points in a second direction other than the forward direction, and
an omnidirectional microphone; and
a processing system configured to combine outputs of the plurality of microphones to create a beamformed directional pattern that points at least approximately in the forward direction.

2. The acoustic beamforming system of claim 1, wherein:
the first directional microphone is coupled to couple a first pair of sound ports;
the second directional microphone is configured to couple a second pair of sound ports;
the omnidirectional microphone is configured to couple to a single sound port; and
the plurality of microphones is arranged such that
the omnidirectional microphone is positioned between the first directional microphone and the second directional microphone,
the first pair of sound ports configured to couple to the first directional microphone, the second pair of sound ports configured to couple to the second directional microphone, and the single sound port configured to couple to the omnidirectional microphone are aligned along a first axis that is at least approximately perpendicular to the forward direction, and
the first directional microphone and the second directional microphone are arranged such that first directional beam pattern and the second directional beam pattern point along the first axis.

3. The acoustic beamforming system of claim 1, wherein:
the first directional microphone is configured to generate a first directional output signal having first dipole beam pattern including a first positive dipole portion and a first negative dipole portion that is out of phase with the first positive dipole portion;
the second directional beam pattern is configured to generate a second directional output signal having a second dipole beam pattern including a second positive dipole portion and a second negative dipole portion that is out of phase with the second positive dipole portion; and
the processing system is configured to generate a differential output signal based on the first directional output signal and the second directional output signal, where the differential output signal comprises a second order dipole beam pattern that is narrower that the first dipole beam pattern and the second dipole beam pattern.

4. The acoustic beamforming system of claim 3, wherein the processing system is further configured to combine the differential output signal with an omnidirectional output signal generated by the omnidirectional microphone, to generate the beamformed directional pattern that points at least approximately in the forward direction.

5. The acoustic beamforming system of claim 4, wherein the processing system is further configured to, prior to combining the differential output signal with the omnidirectional output signal, filter the differential output signal and the omnidirectional output signal with respective matching filters to match amplitudes and phases of the differential output signal and the omnidirectional output signal with one another, respectively.

6. The acoustic beamforming system of claim 4, wherein the processing system is further configured to, prior to generating the differential output signal and combining the differential output signal with the omnidirectional output signal, filter each of the first directional output signal, the second directional output signal, and the omnidirectional output signal with a respective filter.

7. The acoustic beamforming system of claim 2, wherein the plurality of microphones further comprises:
a third directional microphone configured to couple a third pair of sound ports and having a third directional beam pattern, the third directional microphone arranged such that the third directional beam pattern points in a third direction other than the forward direction;
a fourth directional microphone configured to couple to a fourth pair of sound ports and having a fourth directional beam pattern, the fourth directional microphone arranged such that the fourth directional beam pattern points in a fourth direction other than the forward direction; and
the plurality of microphones is further arranged such that
the third pair of sound ports configured to couple to the third directional microphone, the fourth pair of sound ports coupled to couple to the fourth directional microphone, and the single sound port configured to couple to the omnidirectional microphone are aligned along a second axis that is at least approximately perpendicular to the forward direction and at least approximately perpendicular to the first axis, and
the third directional microphone and the fourth directional microphone are arranged such that the third directional beam pattern and the fourth directional beam pattern point along the second axis.

8. The acoustic beamforming system of claim 1, wherein:
the plurality of microphones further comprises a third directional microphone having a third directional beam pattern, the third directional microphone arranged such that the third directional beam pattern points in a third direction other than the forward direction; and
the plurality of microphones is arranged such that
the first directional microphone, the second directional microphone, and the third directional microphone radially surround the omnidirectional microphone and are arranged such that the first directional beam pattern, the second directional beam pattern, and the third directional beam pattern point along respective radial axis around the omnidirectional microphone.

9. The acoustic beamforming system of claim 1, wherein the processing system comprises a digital signal processor.

10. The acoustic beamforming system of claim 1, wherein the plurality of microphones is configured to be integrated into a wall-mounted device.

11. The acoustic beamforming system of claim 1, wherein the plurality of microphones is configured to be integrated into a wall-mounted device that is flush with a wall.

12. An acoustic beamforming system, comprising:
a first directional microphone configured to couple to a first pair of sound ports and having a first directional beam pattern, the first directional microphone arranged such that the first directional beam pattern points in a first direction other than a forward direction;
a second directional microphone configured to couple to a second pair of sound ports and having a second directional beam pattern, the second directional microphone arranged such that the second directional beam pattern points in a second direction other than the forward direction; and
an omnidirectional microphone configured to couple to a single sound port,
wherein
the omnidirectional microphone is positioned between the first directional microphone and the second directional microphone,
the first pair of sound ports configured to couple to the first directional microphone, the second pair of sound ports configured to couple to the second directional microphone, and the single sound port configured to couple to the omnidirectional microphone are aligned along a first axis that is at least approximately perpendicular to the forward direction, and
the first directional microphone and the second directional microphone are arranged such that the first directional beam pattern and the second directional beam pattern point along the first axis.

13. The acoustic beamforming system of claim 12, further comprising a processing system configured to combine outputs of the first directional microphone, the second directional microphone, and the omnidirectional microphone to create a beamformed directional pattern that points at least approximately in the forward direction.

14. The acoustic beamforming system of claim 13, wherein:
the first directional microphone is configured to generate a first directional output signal having first dipole beam pattern including a first positive dipole portion and a first negative dipole portion that is out of phase with the first positive dipole portion;
the second directional microphone is configured to generate a second directional output signal having a second dipole beam pattern including a second positive dipole portion and a second negative dipole portion that is out of phase with the second positive dipole portion; and
the processing system is configured to generate a differential output signal based on the first directional output signal and the second directional output signal, where the differential output signal comprises a second order dipole beam pattern that is narrower that the first dipole beam pattern and the second dipole beam pattern.

15. The acoustic beamforming system of claim 14, wherein the processing system is further configured to combine the differential output signal with an omnidirectional output signal generated by the omnidirectional microphone, to generate the beamformed directional pattern that points at least approximately in the forward direction.

16. The acoustic beamforming system of claim 15, wherein the processing system is further configured to, prior to combining the differential output signal with the omnidirectional output signal, filter the differential output signal and the omnidirectional output signal with respective matching filters to match amplitudes and phases of the differential output signal and the omnidirectional output signal with one another, respectively.

17. The acoustic beamforming system of claim 15, wherein the processing system is further configured to, prior to generating the differential output signal and combining the differential output signal with the omnidirectional output signal, filter each of the first directional output signal, the second directional output signal, and the omnidirectional output signal with a respective filter.

18. The acoustic beamforming system of claim 12, further comprising:
a third directional microphone configured to couple to a third pair of sound ports and having a third directional beam pattern, the third directional microphone arranged such that the third directional beam pattern points in a third direction other than the forward direction; and
a fourth directional microphone configured to couple to a fourth pair of sound ports and having a fourth directional beam pattern, the fourth directional microphone arranged such that the fourth directional beam pattern points in a fourth direction other than the forward direction,
wherein
the third pair of sound ports configured to couple to the third directional microphone, the fourth pair of sound ports configured to couple to the fourth directional microphone, and the single sound port configured to couple to the omnidirectional microphone are aligned along a second axis that is at least approximately perpendicular to the forward direction and at least approximately perpendicular to the first axis, and
the third directional microphone and the fourth directional microphone are arranged such that the third directional beam pattern and the fourth directional beam pattern point along the second axis.

19. The acoustic beamforming system of claim 12, further comprising:
a third directional microphone having a third directional beam pattern, the third directional microphone arranged such that the third directional beam pattern points in a third direction other than the forward direction,
wherein the first directional microphone, the second directional microphone, and the third directional microphone radially surround the omnidirectional microphone and are arranged such that the first directional beam pattern, the second directional beam pattern, and the third directional beam pattern point along respective radial axis around the omnidirectional microphone.
